(19) United States
(12) Patent Application Publication
(10) Pub. No.: US 2023/0206924 A1
(43) Pub. Date: Jun. 29, 2023

(54) VOICE WAKEUP METHOD AND VOICE WAKEUP DEVICE

(71) Applicant: MEDIATEK INC., Hsin-Chu (TW)

(72) Inventors: Chao-Ling Hsu, Hsinchu City (TW); Yiou-Wen Cheng, Hsinchu City (TW); Cheng-Kuan Wei, Hsinchu City (TW)

(73) Assignee: MEDIATEK INC., Hsin-Chu (TW)

(21) Appl. No.: 17/855,786

(22) Filed: Jun. 30, 2022

Related U.S. Application Data
(60) Provisional application No. 63/293,666, filed on Dec. 24, 2021.

(51) Int. Cl. G10L 17/02; G10L 15/08; G10L 15/04

(52) U.S. Cl. CPC G10L 17/02; G10L 15/08; G10L 15/04; G10L 2015/088

(57) ABSTRACT

A voice wakeup method is applied to wake up an electronic apparatus. The voice wakeup method includes executing a speaker identification function to analyze user voice and acquire a predefined identification of the user voice, executing a voiceprint extraction function to acquire a voiceprint segment of the user voice, executing an on-device training function via the voiceprint segment to generate an updated parameter, and utilizing the updated parameter to calibrate a speaker verification model, so that the speaker verification model is used to analyze a wakeup sentence and decide whether to wake up the electronic apparatus.

### CROSS REFERENCE TO RELATED APPLICATIONS

This application claims the benefit of U.S. Provisional Application No. 63/293,666, filed on Dec. 24, 2021. The content of the application is incorporated herein by reference.

### BACKGROUND

With the advanced technology, the electronic apparatus may provide a voice wakeup function, and the electronic apparatus can be turned on or off by verifying whether a voice command is produced by an authorized owner of the electronic apparatus. Therefore, voice of the authorized owner has to be manually enrolled for voiceprint extraction and then stored in the electronic apparatus. When the electronic apparatus receives testing voice of an unknown user, the speaker verification engine of the electronic apparatus verifies whether the testing voice belongs to the authorized owner, and the keyword detection engine of the electronic apparatus detects whether the testing voice contains a predefined keyword. The electronic apparatus wakes up a specific function, such as lighting the display of the electronic apparatus, in accordance with a verification result and a detection result. However, the voiceprint of the user may be changed slowly over time due to a physical status and/or a psychological status of the user, so that the conventional voice wakeup function of the electronic apparatus may not correctly verify the authorized owner in response to the voiceprint enrolled long time ago.

### SUMMARY

The present invention provides a voice wakeup method and a related voice wakeup device without enrollment of user voice for solving above drawbacks.

According to the claimed invention, a voice wakeup method is applied to wake up an electronic apparatus. The voice wakeup method includes executing a speaker identification function to analyze user voice and to acquire a predefined identification of the user voice, executing a voiceprint extraction function to acquire a voiceprint segment of the user voice, executing an on-device training function via the voiceprint segment to generate an updated parameter, and utilizing the updated parameter to calibrate a speaker verification model, so that the speaker verification model is used to analyze a wakeup sentence and decide whether to wake up the electronic apparatus.

According to the claimed invention, the speaker verification model comprises a speaker verification function and a keyword detection function, the speaker verification function decides whether the wakeup sentence conforms to the predefined identification, the keyword detection function decides whether the wakeup sentence contains a keyword. The voice wakeup method further includes executing a keyword detection function to decide whether the user voice contains a keyword, and executing the speaker identification function by the user voice containing the keyword. The speaker identification function analyzes at least one of an appearing period and an appearing frequency of the user voice to determine whether the user voice belongs to the predefined identification.

According to the claimed invention, the voice wakeup method further includes determining whether the user voice conforms to enrolled voice, and executing the speaker identification function by the user voice conforming to the enrolled voice. The user voice conforming to the enrolled voice is analyzed by the speaker verification model to decide whether to wake up the electronic apparatus. The voiceprint segment of the user voice is extracted to compare with voiceprint of the enrolled voice.

According to the claimed invention, the voice wakeup method further includes collecting a larger number of keyword utterances from the user voice, dividing the larger number of keyword utterances into a first voice group belonging to the predefined identification and a second voice group not belonging to the predefined identification, and executing a keyword quality control function to select some keyword utterances having good quality from the first voice group, so that the foresaid keyword utterances is applied for the voiceprint extraction function and the on-device training function. Communication content of the electronic apparatus is recorded to collect the larger number of keyword utterances.

According to the claimed invention, the speaker identification function analyzes a specific keyword of enrolled voice to identify the predefined identification of the user voice. The speaker identification function analyzes voiceprint of enrolled voice to identify the predefined identification of the user voice. The speaker identification function collects a larger number of keyword utterances from the user voice and executes a clustering function to identify the predefined identification of the user voice.

According to the claimed invention, the keyword quality control function utilizes a decision maker to analyze a signal to noise ratio of each keyword utterance, a score of the said keyword utterance in a speaker verification function, and a score of the said keyword utterance in a keyword detection function to decide whether the said keyword utterance is applied for the on-device training function. The on-device training function adjusts at least one parameter of plural user voice to increase various types of each user voice, and analyzes the voiceprint segment of the various types to distinguish the plural user voice from each other. The on-device training function adjusts at least one parameter of plural user voice to increase various types of each user voice, and calibrates the on-device training function via the various types to distinguish specific user voice from other user voice in the plural user voice.

According to the claimed invention, the voice wakeup method further includes receiving ambient noise continuously when a noise reduction function is switched on or off, and executing the on-device training function to analyze the ambient noise for updating the noise reduction function. The noise reduction function transmits the wakeup sentence to the speaker verification model for analysis when the wakeup sentence conforms to the predefined identification and contains a keyword.

According to the claimed invention, a voice wakeup device is applied to wake up an electronic apparatus. The voice wakeup device includes a voice receiver adapted to receive user voice, and an operation processor electrically connected to the voice receiver. The operation processor is adapted to execute a speaker identification function for analyzing the user voice and acquiring a predefined identification of the user voice, to execute a voiceprint extraction function for acquiring a voiceprint segment of the user voice, to execute an on-device training function via the voiceprint segment for generating an updated parameter, and to utilize the updated parameter to calibrate a speaker verification model, so that the speaker verification model is used to analyze a wakeup sentence and decide whether to wake up the electronic apparatus.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a voice wakeup device according to an embodiment of the present invention.

FIG. 2 is a flow chart of the voice wakeup method according to the embodiment of the present invention.

FIG. 3 is an application diagram of the voice wakeup device according to the embodiment of the present invention.

FIG. 4 is a flow chart of the voice wakeup method according to another embodiment of the present invention.

FIG. 5 is an application diagram of the voice wakeup device according to another embodiment of the present invention.

FIG. 6 is a diagram of the speaker identification function according to the embodiment of the present invention.

FIG. 7 and FIG. 8 are application diagrams of the voice wakeup device according to other embodiments of the present invention.

### DETAILED DESCRIPTION

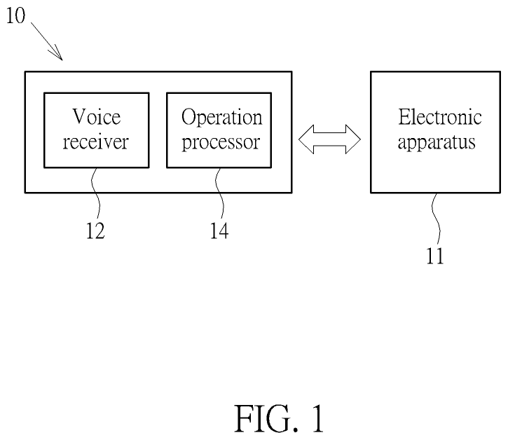

Please refer to FIG. 1. FIG. 1 is a functional block diagram of a voice wakeup device 10 according to an embodiment of the present invention. The voice wakeup device 10 can be applied for an electronic apparatus 11, such as the smart phone or the smart speaker, which depends on a design demand. The electronic apparatus 11 can be a type of loudspeaker and voice command device with an integrated virtual assistant that offers interactive actions and hands-free activation with the help of one “keyword”. The voice wakeup device 10 and the electronic apparatus 11 may be implemented in a same product, or may be two separated products connected to each other in a wire manner or in a wireless manner. The voice wakeup device 10 does not enroll user voice manually. The voice wakeup device 10 can analyze whether the user voice conforms to the keyword in common communication, and identify the user voice which conforms to the keyword for further verification.

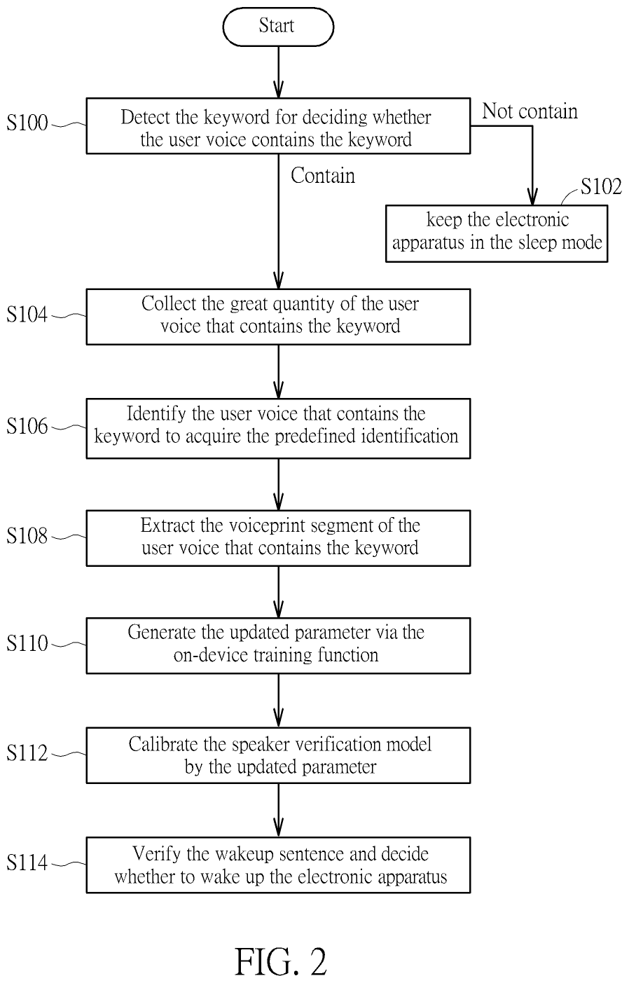

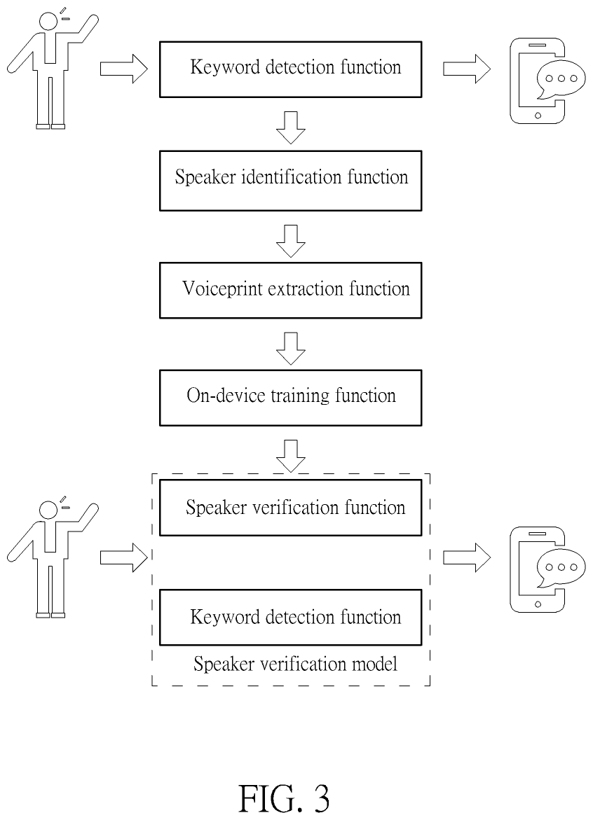

The voice wakeup device 10 can include a voice receiver 12 and an operation processor 14. The voice receiver 12 can receive the user voice from an external microphone, or can be the microphone used to receive the user voice. The operation processor 14 can be electrically connected to the voice receiver 12 and used to execute a voice wakeup method of the present invention. Please refer to FIG. 2 and FIG. 3. FIG. 2 is a flow chart of the voice wakeup method according to the embodiment of the present invention. FIG. 3 is an application diagram of the voice wakeup device 10 according to the embodiment of the present invention. The voice wakeup method illustrated in FIG. 2 can be applied for the voice wakeup device 10 shown in FIG. 1.

First, step S100 can execute a keyword detection function to decide whether the user voice contains the keyword. The keyword can be preset by the user and stored in a memory of the voice wakeup device 10. If the user voice does not contain the keyword, step S102 can be executed to keep the electronic apparatus 11 in a sleep mode. If the user voice contains the keyword, step S104 can switch the electronic apparatus 11 from the sleep mode to a wakeup mode and collect a great quantity of the user voice that contains the keyword. In steps S100, S102 and S104, the keyword detection function does not identify or verify the user voice, and only decides the user voice contains the keyword or not via machine learning.

Then, step S106 can execute a speaker identification function to analyze the user voice containing the keyword and acquire a predefined identification of the user voice. The speaker identification function can identify one or some of the great quantity of the user voice belongs to the predefined identification, such as an owner of the electronic apparatus 11. In a possible embodiment, the speaker identification function may analyze at least one of an appearing period and an appearing frequency of the great quantity of the user voice. If the appearing period is greater than a preset period threshold and/or the appearing frequency is higher than a preset frequent threshold, the speaker identification function can determine that the related user voice belongs to the predefined identification.

As the user voice belonging to the predefined identification is determined, steps S108 and S110 can execute a voiceprint extraction function to acquire a voiceprint segment of the determined user voice, and execute an on-device training function via the voiceprint segment to generate an updated parameter. Then, steps S112 and S114 can utilize the updated parameter to calibrate a speaker verification model, and the speaker verification model can be used to analyze a wakeup sentence and decide whether to wake up the electronic apparatus 11. The voiceprint extraction function may utilize spectral analysis or any applicable technology to acquire the voiceprint segment. The on-device training function can analyze variation of the user voice via the voiceprint segment at any time to immediately calibrate the speaker verification model.

The voice wakeup device 10 does not enroll the user voice manually, and can identify which one or some of the great quantity of the user voice is made by the owner of the electronic apparatus 11. When the owner is identified, the voiceprint segment of the user voice belonging to the owner can be extracted and applied to the on-device training function for calibrating the speaker verification model, and therefore the speaker verification model can accurately verify the follow-up wakeup sentence to wake up the electronic apparatus 11. The speaker verification model can have a speaker verification function and a keyword detection function. The speaker verification function can decide the wakeup sentence conforms to or does not conform to the predefined identification. The keyword detection function can decide whether the wakeup sentence contains the keyword. If the wakeup sentence conforms to the predefined identification and contains the keyword, the electronic apparatus 11 can be awakened accordingly.

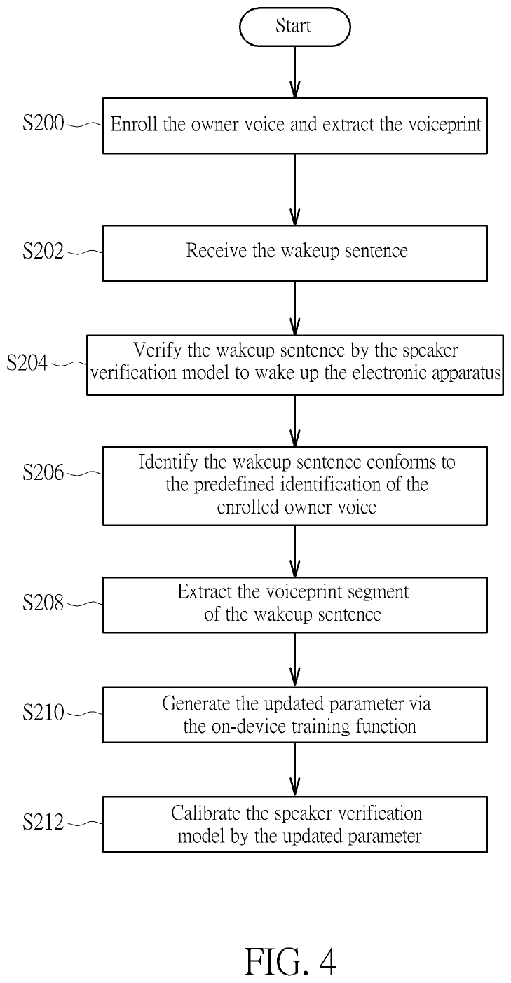

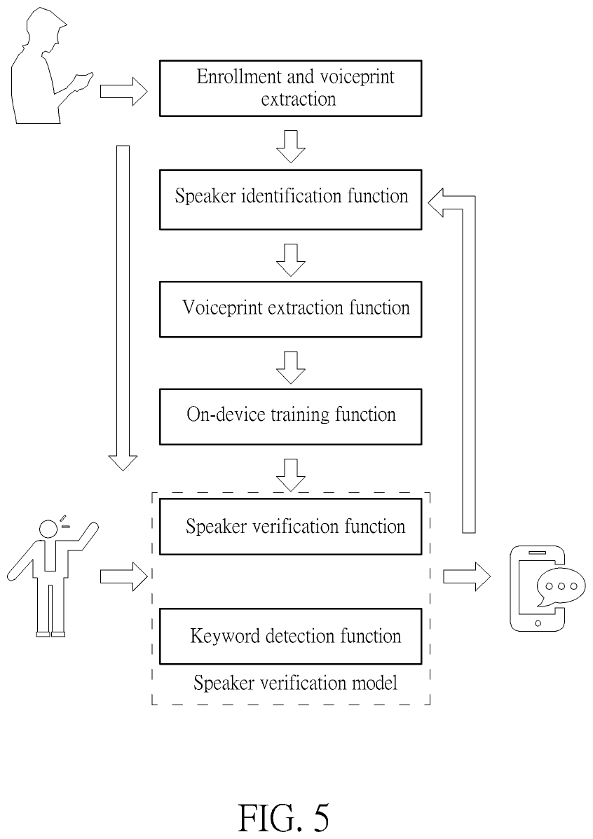

Please refer to FIG. 4 and FIG. 5. FIG. 4 is a flow chart of the voice wakeup method according to another embodiment of the present invention. FIG. 5 is an application diagram of the voice wakeup device 10 according to another embodiment of the present invention. The voice wakeup method illustrated in FIG. 4 can be applied for the voice wakeup device 10 shown in FIG. 1. First, step S200 can execute voice enrollment and related voiceprint extraction. The user voice enrolled and received by the voice receiver 12 can be the enrolled owner voice. The enrolled owner voice be applied to the speaker verification model for increasing verification accuracy, and further applied to the speaker identification function for calibrating the speaker verification model. Then, steps S202 and S204 can execute to receive the wakeup sentence via the voice receiver 12, and verify the wakeup sentence by the speaker verification model to decide whether to wake up the electronic apparatus 11.

If the wakeup sentence is verified, steps S206, S208 and S210 can identify whether the wakeup sentence conforms to the predefined identification of the enrolled owner voice, and extract the voiceprint segment of the wakeup sentence to compare with voiceprint of the enrolled owner voice, and execute the on-device training function via the extracted voiceprint segment to generate the updated parameter. When the updated parameter is generated, step S212 can utilize the updated parameter to calibrate the speaker verification model. However, in some possible embodiment, the speaker verification model may be calibrated by the voiceprint extraction acquired in step S200, so that the wakeup sentence conforming to the enrolled owner voice can be analyzed by the speaker verification model to decide whether to wake up the electronic apparatus 11.

The speaker verification model can have the speaker verification function and the keyword detection function that have the same feature as ones of the foresaid embodiment, and a detailed description is omitted herein for simplicity. It should be mentioned that some verification results of the speaker verification model can be collected to choose some of the voiceprint segment applied to the speaker identification function, the voiceprint extraction function and the on-device training function for further calibrating the speaker verification model. The voice wakeup device 10 can learn voice change of the owner of the electronic apparatus 11 for calibrating the speaker verification model in real time, no matter whether the owner voice is enrolled or not.

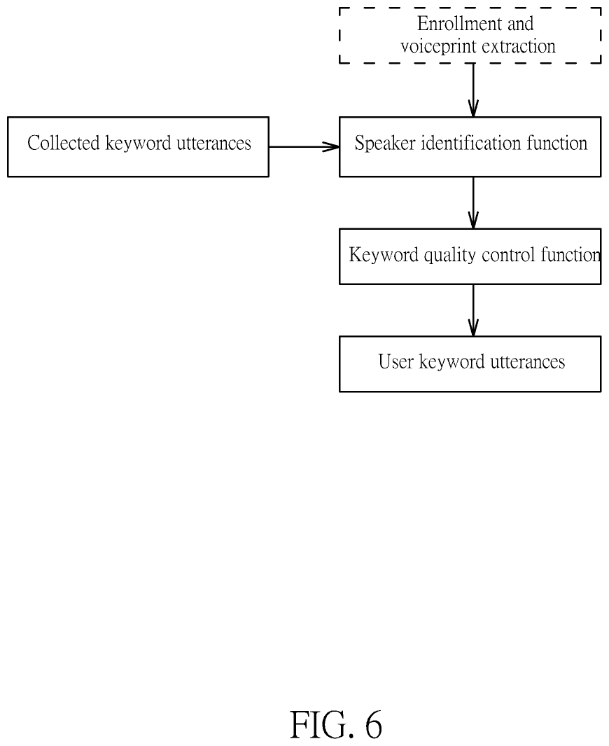

Please refer to FIG. 6. FIG. 6 is a diagram of the speaker identification function according to the embodiment of the present invention. The speaker identification function can collect a larger number of keyword utterances from the user voice by recording communication content of the electronic apparatus 11 if there has no voice enrollment. The larger number of keyword utterances can be divided into several groups via the speaker identification function, such as a first voice group having the keyword by the predefined identification, a second voice group having the keyword by undefined identification, a third voice group having similar words and a fourth voice group having different words. The first voice group may include the keyword utterances with good quality and the keyword utterances with bad quality, so that a keyword quality control function can be executed to select some keyword utterances having the good quality from the first voice group, and the keyword utterances having the good quality can be applied for the voiceprint extraction function and the on-device training function.

In some possible embodiment, results of the voice enrollment and the related voiceprint extraction can be optionally applied to the speaker identification function, and the speaker identification function can analyze one of the larger number of keyword utterances and the voiceprint of the enrolled voice to identify whether the keyword utterances belong to the owner. The speaker identification function can identify the predefined identification of the user voice via a variety of manners. For example, if enrollment voiceprint is available, a supervised manner can analyze a specific keyword of the enrolled owner voice to identify the predefined identification of the user voice; if there has no enrollment and the voiceprint is acquired by other sources, such as daily phone call, the supervised manner can analyze the voiceprint of the enrolled owner voice to identify the predefined identification of the user voice. In an unsupervised manner, the speaker identification function can collect the larger number of keyword utterances from the user voice and execute a clustering function or any similar functions to identify the predefined identification of the user voice.

In addition, the voice wakeup device 10 can optionally compute a score of each keyword utterance in the speaker verification function and the keyword detection function, and further compute a signal to noise ratio of each keyword utterance and other available quality scores. Then, the keyword quality control function can utilizes a decision maker to analyze the signal to noise ratio of each keyword utterance, and the scores of each keyword utterance in the speaker verification function and the keyword detection function to decide whether each of the larger number of keyword utterances can be a candidate utterance applied for the on-device training function. The said other available quality scores can optionally be a simple heuristic logic that using some if/else to manage voice quality and noise quality.

The on-device training function can augment the enrolled voice and/or the wakeup sentence to enhance the robust voiceprint. At least one parameter of the plural user voice can be adjusted to augment various types of each user voice, so as to distinguish the plural user voice from each other by analysis of the voiceprint segment in the various types; for example, the data augmentation process for the on-device training function can include various techniques, such as mixing noises, changing speech speed, adjusting reverberation or intonation, increasing or decreasing loudness, or changing pitch or accent, which depends on the design demand. In the embodiments shown in FIG. 3 and FIG. 5, the on-device training function can retrain and update the resulting voiceprint as a speaker model (which may be interpreted as the voiceprint segment of the user voice) for the speaker verification model, and further retrain and update the speaker verification model to enhance the voice extraction function.

The voice extraction function can be used to extract characteristics of the user voice. An optimization process of the on-device training function can maximize a distance between the same keyword pronounced by different users in the training set for embedded feature vectors. The wakeup sentence may be composed of the keyword and the voiceprint. The keyword in the wakeup sentences from several users are the same, and can be removed by maximizing the foresaid distance. The voiceprints in the wakeup sentences from several users are different, and can be embedded for the speaker verification model. Besides, a back propagation function can be generally used to retrain the voiceprint extraction function. If the on-device training function is not cooperated with the back propagation function, only the speaker model can be updated in a process of the on-device training function; the resulting new speaker model can be used to optionally update the original speaker model or store as the new speaker model. The updated or new speaker model, the previous speaker model, the enrolled speaker model, and the speaker models from various sources (e.g. phone call) can be applied for the speaker verification model.

If the on-device training function is cooperated with the back propagation function, the speaker model and the voiceprint extraction function can be updated in the process of the on-device training function; the distance between the same keyword pronounced by the specific user (such as the owner of the electronic apparatus 11) and other users can be maximized in the training set, and the specific user can be distinguished from other users, so that the updated or new speaker model, the previous speaker model, the enrolled speaker model, and the speaker models from various sources can be applied for the speaker verification mode to accurately wake up the electronic apparatus 11.

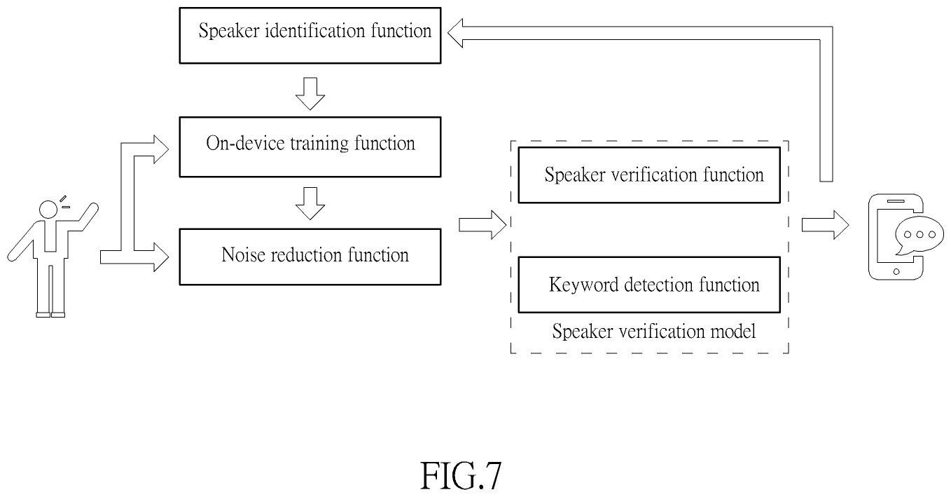

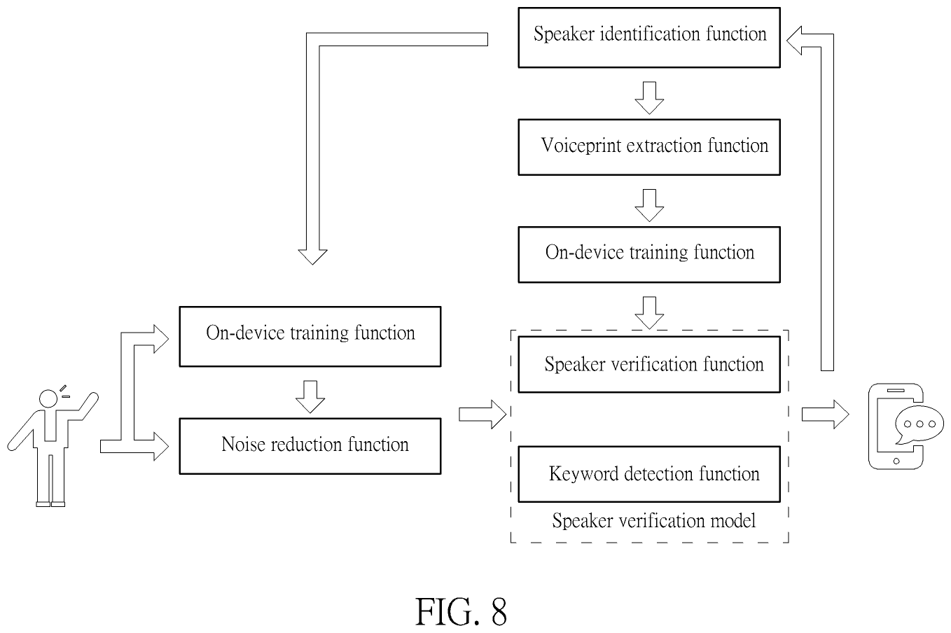

Please refer to FIG. 7 and FIG. 8. FIG. 7 and FIG. 8 are application diagrams of the voice wakeup device 10 according to other embodiments of the present invention. The voice wakeup device 10 can have a noise reduction function, and the noise reduction function can be implemented in various ways, such as methods based on neural network model or hidden markov model, or signal processing based on wiener filter or other ways. The noise reduction function can record ambient noise and learn noise statistic for self-updating the noise reduction function when the noise reduction function is switched on or off In some embodiments, when the voice wakeup device 10 is not powered off, the voice wakeup device 10 can always record ambient noise for self-updating the noise reduction function no matter the noise reduction function is switched on or off. The on-device training function for the noise reduction function can be preferably applied when the wakeup sentence is unlikely from the owner of the electronic apparatus 11, so that false cancellation of the owner voice does not happen.

For example, when the wakeup sentence is received by the voice wakeup device 10, the noise reduction function may be optionally applied to reduce noise in the wakeup sentence for a start. If the speaker verification model determines that the wakeup sentence conforms to the predefined identification and contains the keyword, a related score or any available signals may be optionally output to the speaker identification function, and the electronic apparatus 11 can be awakened; if the speaker verification model determines that the wakeup sentence does not conform to the predefined identification or not contain the keyword, the score or the related available signals can be output to the speaker identification function. If the speaker identification function identifies that the wakeup sentence does not belong to the owner of the electronic apparatus 11, the on-device training function can be applied to accordingly update the noise reduction function, as shown in FIG. 7.

As shown in FIG. 8, the noise reduction function can reduce noise in the wakeup sentence, and the speaker verification model can determine whether the wakeup sentence conforms to the predefined identification and contains the keyword, for outputting the score or the available signals to the speaker identification function. If the speaker identification function identifies that the wakeup sentence belongs to the owner of the electronic apparatus 11, the voiceprint extraction function and the on-device training function can be executed to calibrate the speaker verification model; if the speaker identification function identifies that the wakeup sentence does not belong to the owner of the electronic apparatus 11, another on-device training function can be executed for calibrating the noise reduction function.

In conclusion, the voice wakeup method and the voice wakeup device of the present invention can collect the great quantity of the user voice, and analyze the user voice via the on-device training function to calibrate or update the speaker verification model. The owner voice enrollment is optional; the speaker identification can identify some of the great quantity of the user voice for the voiceprint extraction function and the on-device training function, or identify some of the verification results and the voice enrollment for the voiceprint extraction function and the on-device training function. The noise reduction function can be used to filter ambient noise and output the de-noise signal. The speaker identification function can identify the user voice that does not belong to the owner for updating the noise reduction function through the on-device training function, so that the electronic apparatus 11 can be accurately awaked by the voice wakeup method and the voice wakeup device of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A voice wakeup method applied to wake up an electronic apparatus, the voice wakeup method comprising
executing a speaker identification function to analyze user voice and to acquire a predefined identification of the user voice;
executing a voiceprint extraction function to acquire a voiceprint segment of the user voice;
executing an on-device training function via the voiceprint segment to generate an updated parameter; and
utilizing the updated parameter to calibrate a speaker verification model so that the speaker verification model is used to analyze a wakeup sentence and decide whether to wake up the electronic apparatus.

2. The voice wakeup method of claim 1, wherein the speaker verification model comprises a speaker verification function and a keyword detection function, the speaker verification function decides whether the wakeup sentence conforms to the predefined identification, the keyword detection function decides whether the wakeup sentence contains a keyword.

3. The voice wakeup method of claim 1, further comprising:
executing a keyword detection function to decide whether the user voice contains a keyword; and
executing the speaker identification function by the user voice containing the keyword.

4. The voice wakeup method of claim 1, wherein the speaker identification function analyzes at least one of an appearing period and an appearing frequency of the user voice to determine whether the user voice belongs to the predefined identification.

5. The voice wakeup method of claim 1, further comprising:
determining whether the user voice conforms to enrolled voice; and
executing the speaker identification function by the user voice conforming to the enrolled voice.

6. The voice wakeup method of claim 5, wherein the user voice conforming to the enrolled voice is analyzed by the speaker verification model to decide whether to wake up the electronic apparatus.

7. The voice wakeup method of claim 5, further comprising:
extracting the voiceprint segment of the user voice to compare with voiceprint of the enrolled voice.

8. The voice wakeup method of claim 1, wherein the on-device training function analyzes variation of the user voice at any time to immediately calibrate the speaker verification model.

9. The voice wakeup method of claim 1, wherein executing the speaker identification function to analyze the user voice comprises:
collecting a larger number of keyword utterances from the user voice;
dividing the larger number of keyword utterances into a first voice group belonging to the predefined identification and a second voice group not belonging to the predefined identification; and
executing a keyword quality control function to select some keyword utterances having good quality from the first voice group, so that the foresaid keyword utterances is applied for the voiceprint extraction function and the on-device training function.

10. The voice wakeup method of claim 9, wherein communication content of the electronic apparatus is recorded to collect the larger number of keyword utterances.

11. The voice wakeup method of claim 1, wherein the speaker identification function analyzes a specific keyword of enrolled voice to identify the predefined identification of the user voice.

12. The voice wakeup method of claim 1, wherein the speaker identification function analyzes voiceprint of enrolled voice to identify the predefined identification of the user voice.

13. The voice wakeup method of claim 1, wherein the speaker identification function collects a larger number of keyword utterances from the user voice and executes a clustering function to identify the predefined identification of the user voice.

14. The voice wakeup method of claim 9, wherein the keyword quality control function utilizes a decision maker to analyze a signal to noise ratio of each keyword utterance, a score of the said keyword utterance in a speaker verification function, and a score of the said keyword utterance in a keyword detection function to decide whether the said keyword utterance is applied for the on-device training function.

15. The voice wakeup method of claim 1, wherein the on-device training function adjusts at least one parameter of plural user voice to increase various types of each user voice, and analyzes the voiceprint segment of the various types to distinguish the plural user voice from each other.

16. The voice wakeup method of claim 1, wherein the on-device training function adjusts at least one parameter of plural user voice to increase various types of each user voice, and calibrates the on-device training function via the various types to distinguish specific user voice from other user voice in the plural user voice.

17. The voice wakeup method of claim 1, further comprising:
receiving ambient noise continuously when a noise reduction function is switched on or off; and
executing the on-device training function to analyze the ambient noise for updating the noise reduction function.

18. The voice wakeup method of claim 17, wherein the noise reduction function transmits the wakeup sentence to the speaker verification model for analysis when the wakeup sentence conforms to the predefined identification and contains a keyword.

19. A voice wakeup device applied to wake up an electronic apparatus, the voice wakeup device comprising:
a voice receiver adapted to receive user voice; and
an operation processor electrically connected to the voice receiver, the operation processor being adapted to execute a speaker identification function for analyzing the user voice and acquiring a predefined identification of the user voice, to execute a voiceprint extraction function for acquiring a voiceprint segment of the user voice, to execute an on-device training function via the voiceprint segment for generating an updated parameter, and to utilize the updated parameter to calibrate a speaker verification model, so that the speaker verification model is used to analyze a wakeup sentence and decide whether to wake up the electronic apparatus.
